(19) United States
(12) Patent Application Publication
(10) Pub. No.: US 2009/0096750 A1
(43) Pub. Date: Apr. 16, 2009

(54) SCROLL WHEEL DEVICE

(76) Inventor: Wen-Chin LEE, Xinzhuang City (TW)

Correspondence Address: LEONG C LEI, PMB # 1008, 1867 YGNACIO VALLEY ROAD, WALNUT CREEK, CA, 94598, US

(21) Appl. No.: 11/871,164

(22) Filed: Oct. 12, 2007

(51) Int. Cl. G06F 3/033

(52) U.S. Cl. 345/163

(57) ABSTRACT

The major characteristic of the present invention lies in the adoption of electromagnetic means to translate the spin of a wheel module into continuous electrical signals. A permanent magnet is incorporated in the wheel module to provide magnetic field. Two sensors tangential to the spinning direction of the permanent magnet are used to detect the variations of the magnetic field from the spin of the wheel module in accordance with the Hall Effect.

### TECHNICAL FIELD OF THE INVENTION

The present invention generally relates to pointing devices, and more particularly to a scroll wheel device for use in a pointing device to translate the spin of a wheel module into corresponding electrical signals.

### DESCRIPTION OF THE PRIOR ART

In addition to the conventional pointing and clicking functions, a recent innovation in computer mice is to integrate a scroll wheel that allows a user to scroll the onscreen image of a document like a Web page or spreadsheet vertically (up/down) and/or horizontally.

Usually a mechanical switch encoder is adopted to translate the spin of the scroll wheel into signals that a computer can use. The mechanical switch encoder has a number of disadvantages. First, as a mechanical means, the switch encoder may suffer deteriorated contact after a period of usage, thereby limiting its operation life. Secondly, with its inherent limitation, the switch encoder has a limited scrolling resolution and cannot provide continuous scrolling.

Even though some computer mice adopt optical encoders to obviate some of the shortcomings of the mechanical switch encoder, the optical encoder still suffers some disadvantages. For example, the scrolling resolution is affected by the diameter of the scroll wheel. To achieve high scrolling resolution, a bigger scroll wheel has to be adopted and the optical encoder is therefore not appropriate for a miniature pointing device. If a smaller scroll wheel is used, the scrolling resolution again is limited.

### SUMMARY OF THE INVENTION

Accordingly, a novel scroll wheel device is provided herein to obviate the shortcomings of the present invention.

The major characteristic of the present invention lies in the adoption of electromagnetic means to perform the translation. A permanent magnet is incorporated in a wheel module to provide magnetic field. Two sensors tangential to the spinning direction of the permanent magnet are used to detect the variations of the magnetic field from the spin of the wheel module in accordance with the Hall Effect.

Compared to conventional mechanical or optical means, the present invention provides a number of advantages. First of all, the scroll wheel device is able to provide analog or continuous electrical signals and therefore is able to achieve significantly greater scrolling resolution and smooth scrolling of the onscreen image. Secondly, the scrolling resolution is not related to the diameter of the wheel module and therefore the scroll wheel device may be integrated into miniature electronic devices.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a first embodiment of the present invention installed inside a computer mouse.

FIG. 2 is a perspective view of the first embodiment of FIG. 1.

FIG. 3 is a perspective exploded view showing the various components of the first embodiment of FIG. 1.

FIG. 4 is a perspective exploded view showing the various components of a second embodiment of the present invention.

FIG. 5 is a sectional view of the first embodiment of FIG. 1.

FIG. 6 is a profile view of the signal extraction unit of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In the following, a computer mouse is mainly used as an example to explain the embodiment of the present invention. However, the principle of the present invention may be readily applied to various types of other pointing or electronic devices.

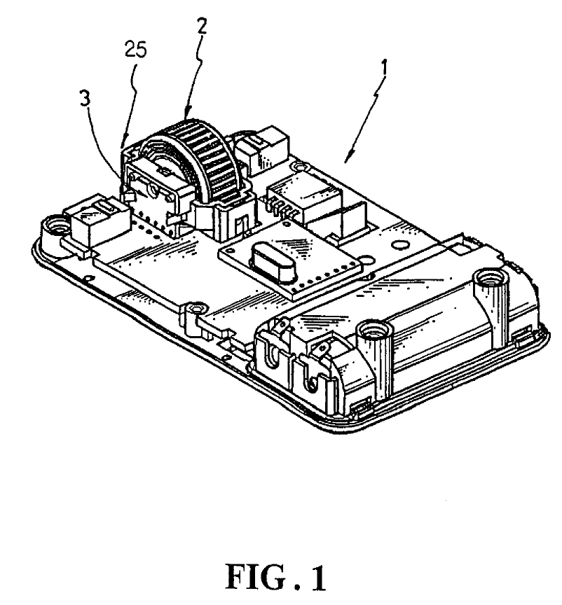

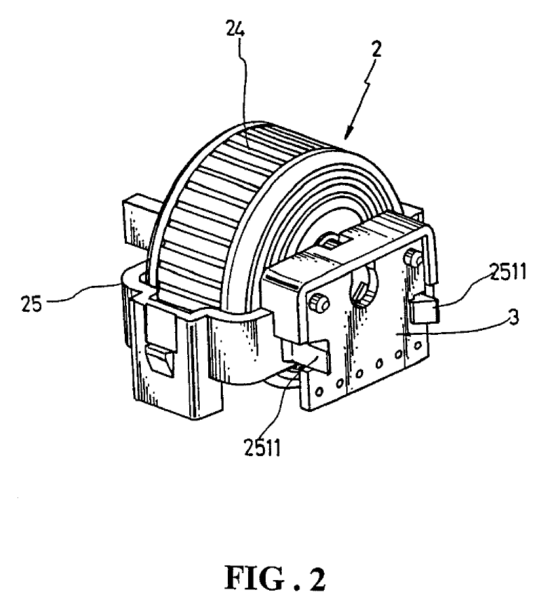

FIG. 1 shows an embodiment of the present invention housed inside a computer mouse 1, with a top cover of the computer mouse 1 removed to reveal the details inside. As further illustrated in FIG. 2, the present embodiment contains a wheel module 2 and a signal extraction unit 3, integrated to a pedestal 25 to jointly provide the function of a scroll wheel.

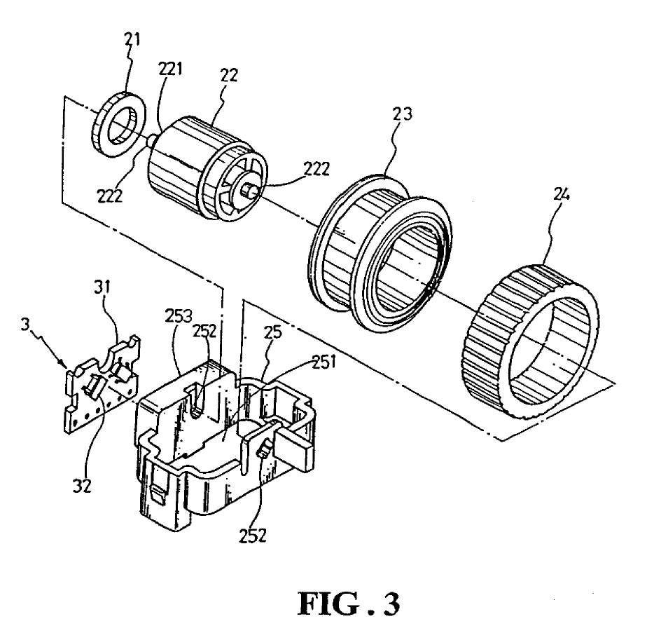

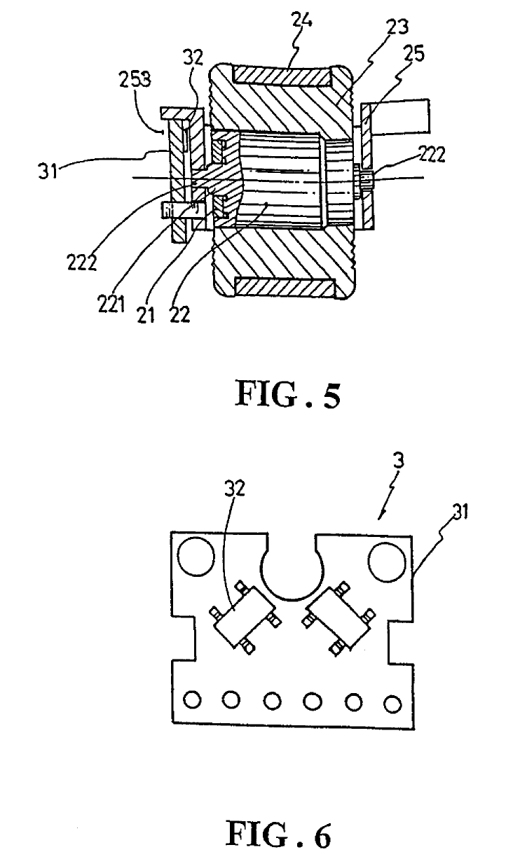

As illustrated in FIGS. 3 and 5, the wheel module 2 contains cylindrical main ring 23 having an anti-slippery ring 24 coaxially embedded in the circumference of the main ring 23. The wheel module 2 further contains cylindrical axle 22 axially threaded in and tightly joined with the main ring 23. The axle 22 has two tips 222 extended beyond its two end surfaces for an appropriate distance. At a first end of the axle 22, the end surface is concaved to form a socket (not numbered) and the tip 222 there has a thicker axial base 221 so that a ring-shaped permanent magnet 21 can be tightly fitted on the thicker base 221 and housed in the socket. The wheel module 2 is assembled as such so that, when the main ring 23 is turned, the axle 22 and the magnet 21 are turned synchronously.

As shown in FIGS. 2, 3, and 5, the pedestal 25 is a frame forming a generally rectangular space 251 for housing the wheel module 2 inside. The pedestal 25 therefore surrounds the wheel module 2 diametrically. There are two corresponding holes 252 on the two opposing longer sides (hereinafter, the first and second sides) of the pedestal 25, respectively, for the accommodation of the tips 222 of the wheel module 2. As such, the wheel module 2 is rotatably mounted on the pedestal 25 with the permanent magnet 21 adjacent to the first side of the pedestal 25. On the outer surface of the first side of the pedestal 25, a rectangular seat 253 is provided to accommodate the approximately rectangular signal extraction unit 3. Also on the outer surface of the first side of the pedestal 25 is a pair of laterally opposing clasps 2511 to reliably hold the signal extraction unit 3 inside the seat 253.

As further shown in FIG. 6, the signal extraction unit 3 is mainly a circuit board 31 having two sensors 32 electrically connected to the circuit board 31. Please note that the two sensors 32 are arranged so that they are tangential to the spinning direction of the permanent magnet 21. According to the Hall Effect, as the permanent magnet 21 turns, the two sensors 32 are able to pick up the variations of the magnetic field produced by the permanent magnet 21 and then translate to corresponding electrical signals.

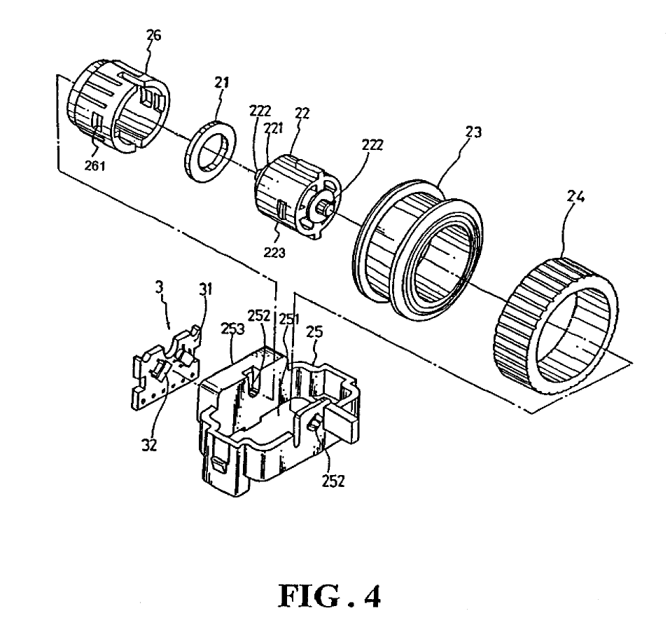

FIG. 4 shows a second embodiment of the present invention to enhance the positioning of the permanent magnet 21. As illustrated, a cylindrical auxiliary ring 26 is provided so that the axle 22 is first threaded axially into a second end of the auxiliary ring 26 and the combination is then threaded axially into the main ring 23. To tightly join the axle 22 and the auxiliary ring 26 together, at least a wedge 223 is provided along the circumference of the axle 22 and at least a notch 261 is provided along the circumference of the auxiliary ring 26, corresponding to the wedge 223. As such, when the axle 22 is threaded into the auxiliary ring 26, the wedge 223 is embedded into the corresponding notch 261. Please note that a first end of the auxiliary ring 26 opposite to the second end has an aperture (not shown) smaller than the diameter of the permanent magnet 21. As such, the permanent magnet 21 is reliably sandwiched between the axle 22 and the auxiliary ring 26.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the split of the present invention.

I claim:

1. A scroll wheel device for a pointing device, comprising:
a wheel module having a ring-shaped permanent magnet and an axle axially threading in a main ring with an anti-slipper ring coaxially embedded in the circumference of said main ring, said permanent magnet threaded by and fitted on a first end of said axle, said wheel module being combined as such so that said permanent magnet, said axle, and said main ring revolving synchronously;
a pedestal onto which said wheel module is rotatably mounted; and
a signal extraction unit mounted on said pedestal adjacent to said first end of said axle, said signal extraction unit having a circuit board with a plurality of sensors electrically connected to said circuit board; wherein said sensors are arranged tangentially to the spinning direction of said permanent magnet so that, when said permanent magnet turns, said sensors are capable of providing continuous electrical signals corresponding to the variations of magnetic field produced by said permanent magnet in accordance with Hall Effect.

2. The scroll wheel device according to claim 1, wherein said pedestal is a frame forming a generally rectangular space for housing said wheel module.

3. The scroll wheel device according to claim 1, wherein said pedestal has a pair of opposing clasps for holding said signal extraction unit.

4. The scroll wheel device according to claim 1, further comprising an auxiliary ring coaxially interposed between said axle and said main ring; a first end of said auxiliary ring is adjacent to said permanent magnet; said first end of said auxiliary ring has an aperture smaller than the diameter of said permanent magnet.

5. The scroll wheel device according to claim 4, wherein the circumference of said axle has at least a wedge; and the circumference of said auxiliary ring has a corresponding notch for embedding said wedge.
